(19) United States
(12) Patent Application Publication
(10) Pub. No.: US 2024/0075472 A1
(43) Pub. Date: Mar. 7, 2024

(54) DIAGNOSTIC APPARATUS USING CONDUCTIVE PLASTIC AND METHOD FOR MANUFACTURING SAME

(71) Applicant: SEQUREMED, INC, Seongnam-Si (KR)

(72) Inventors: Chang Wook Min, Seongnam-Si (KR); Moon Kyung Ahn, Seongnam-Si (KR)

(21) Appl. No.: 18/379,727

(22) Filed: Oct. 13, 2023

Related U.S. Application Data
(63) Continuation of application No. PCT/KR2022/005207, filed on Apr. 11, 2022.

(30) Foreign Application Priority Data
Apr. 13, 2021 (KR) 10-2021-0047718
Nov. 3, 2021 (KR) 10-2021-0149309

(51) Int. Cl. B01L 3/00

(52) U.S. Cl. CPC B01L 3/502715; B29K 2507/04

(57) ABSTRACT

The present invention relates to a diagnostic apparatus and a method for manufacturing the same. The diagnostic apparatus according to an embodiment of the present invention comprises a base plate including an insulator, and one or more electrodes formed by penetrating through the base plate and causing a fluid located on a surface to be moved based on an applied voltage, in which the base plate is formed by injecting the insulator into a first space of a mold by a first injection gate, and the electrode is formed by injecting conductive plastic into a second space of the mold by a second injection gate distinct from the first injection gate.

### BACKGROUND

### Technical Field

The present invention relates to a diagnostic apparatus using electrowetting and a method for manufacturing the same. More specifically, the invention relates to a diagnostic apparatus that allows a simple manufacturing process in which an electrode is formed by injection molding a conductive plastic, and a method for manufacturing the same.

### Description of the Related Art

Electrowetting refers to a phenomenon in which the surface tension of fluid changes due to an electric field applied to the fluid. For example, for fluid whose surface tension changes due to electrowetting, the contact angle between the solid and liquid due to potential difference may be varied depending on the applied electric signals. For another example, the fluid whose surface tension changes due to electrowetting may move on an electrode according to the applied electric signals.

Efforts to utilize such electrowetting continue to be made in various technological fields. For example, efforts of utilizing electrowetting in order to control thickness of camera lenses or to commercialize electronic paper are continuously made.

### SUMMARY

The technical object intended to be addressed by certain embodiments described herein is to provide a diagnostic apparatus having a structure that allows a simpler manufacturing process, and a method for manufacturing the same.

Another technical object intended to be addressed by certain embodiments described herein is to provide a diagnostic apparatus having a structure that may reduce manufacturing costs, and a method for manufacturing the same.

Yet another technical object intended to be addressed by certain embodiments described herein is to provide a diagnostic apparatus that may be used as a disposable cartridge, and a method for manufacturing the same.

The technical objects of the present invention are not limited to those mentioned above, and the other technical objects not mentioned herein may be clearly understood by those skilled in the art from the description below.

In order to solve the technical problems described above, a diagnostic apparatus according to an embodiment may comprise a base plate including an insulator, and one or more electrodes formed by penetrating through the base plate and causing a fluid located on a surface to be moved based on an applied voltage, in which the base plate may be formed by injecting the insulator into a first space of a mold by a first injection gate, and the electrode may be formed by injecting conductive plastic into a second space of the mold by a second injection gate distinct from the first injection gate.

In an embodiment, an upper width of the electrode may be larger than a middle width of the electrode by a first reference size, and a lower width of the electrode may be larger than the middle width of the electrode by a second reference size, and the first reference size may be larger than the second reference size. In an example, a width of the electrode may be tapered from an upper portion of the electrode to a middle portion and tapered from a lower portion of the electrode to the middle portion.

According to an embodiment, the conductive plastic may comprise at least one of carbon nanotubes, graphene, and carbon fiber, and the insulator may comprise at least one of polycarbonate (PC), poly methyl methacrylate (PMMA), cyclic olefin polymer (COP), cyclic olefin copolymer(COC), polyethylene terephthalate(PET), polyimide(PI), polyethylene(PE), acrylic, acrylonitrile butadienestyrene(ABS), polyvinylidene fluoride (PVDF), polytetrafluoroethylene(PTFE), polystyrene(PS), polypropylene (PP) and polyvinyl chrloride (PVC).

According to an embodiment, an upper width of an electrode gap formed by two or more electrodes may be smaller than a lower width of the electrode gap. In an example, a width of the electrode gap may be tapered from a middle portion of the electrode gap toward an upper portion and tapered from the middle portion of the electrode gap toward a lower portion. Further, the base plate of the electrode gap may be formed by injecting the insulator into a lower portion of the electrode gap.

According to an embodiment, the diagnostic apparatus may further comprise a reservoir that guides the fluid contained in the housing. In an example, an adjacent electrode of the electrodes formed in the base plate, which is formed adjacent to the reservoir, may have an upper width larger than an upper width of the other electrode formed in the base plate. In an example, a number of adjacent electrodes may be determined based on the size of the reservoir.

According to an embodiment, compared to the related diagnostic apparatus manufacturing process including photo process, metal deposition process, etching process, etc., it is possible to provide a diagnostic apparatus with a structure that can increase yield and reduce defect rate through a very simple injection molding process.

According to the embodiment, it is possible to provide a diagnostic apparatus having a structure that allows smooth flow of the fluid contained in the housing along the reservoir and the electrodes based on the electrowetting signal.

The effects of the present disclosure are not limited to those described above, and other effects not mentioned herein will be readily understood by those of ordinary skill in the art (referred to as “those skilled in the art”) from the description of the claims.

### BRIEF DESCRIPTION OF THE DRAWINGS

FIG. 1 is an exemplary view of a diagnostic apparatus according to an embodiment of the present invention.

FIG. 2 is an exemplary view of an upper portion of an electrode plate described with reference to FIG. 1.

FIG. 3 is an exemplary view of a lower portion of the electrode plate described with reference to FIG. 1.

FIG. 4 is an exemplary cross-sectional view of the electrode plate described with reference to FIG. 1.

FIG. 5 is an exemplary view provided to explain in more detail a housing and the electrode plate described with reference to FIG. 1.

FIG. 6 is an exemplary view provided to explain in more detail a structure of an electrode described with reference to FIGS. 2 to 4.

FIG. 7 is an exemplary view provided to explain in more detail a structure of a base plate described with reference to FIGS. 2 to 4.

FIG. 8 is another exemplary view of an upper portion of the electrode plate described with reference to FIG. 1.

### DETAILED DESCRIPTION OF EMBODIMENT

Hereinafter, embodiments of the present invention will be described in detail with reference to the attached drawings. Advantages and features of the present disclosure and methods of accomplishing the same will be apparent by referring to embodiments described below in detail in connection with the accompanying drawings. However, the technical idea of the present invention is not limited to the following embodiments, and may be implemented in various different forms and the following embodiments are merely provided to complete the technical idea of the present invention and to help those skilled in the art to which the present invention pertains understand the scope of the present invention completely, and the technical idea of the present invention is only defined by the scope of the claims.

It should be noted that, in adding reference numerals to the components of the drawings, the same components are denoted by the same reference numerals even if they are illustrated in different drawings. In the following description of the present disclosure, a detailed description of known functions and configurations incorporated herein will be omitted when it may make the subject matter of the present disclosure rather unclear.

Unless otherwise defined, all terms (including technical and scientific terms) used herein may be used with meanings that can be commonly understood by those skilled in the art to which the present invention pertains. Further, terms defined in commonly used dictionaries are not interpreted ideally or excessively unless clearly specifically defined. The terms are used herein for the purpose of describing the embodiments and not intended to limit the invention. In the description, a singular expression also includes a plural expression unless specifically stated otherwise in the context.

Further, while describing the components of the present disclosure, “first,” “second,” “A,” “B,” “(a),” “(b)” and so on may be used. However, these are used solely for the purpose of distinguishing one component from another, and do not limit the nature, sequence or order of the corresponding components. When a component is described as being “connected,” “coupled,” or “contacted” to another component, that component may be directly connected or contacted to another component, but it is to be understood that yet another component may be “connected,” “coupled,” or “contacted” between the two components.

As used herein, “comprises” and/or “comprising” does not foreclose the presence or addition of one or more other elements, steps, operations, and/or devices in addition to the recited elements, steps, operations, or devices.

Hereinafter, various embodiments of the present invention will be described in detail with reference to the attached drawings.

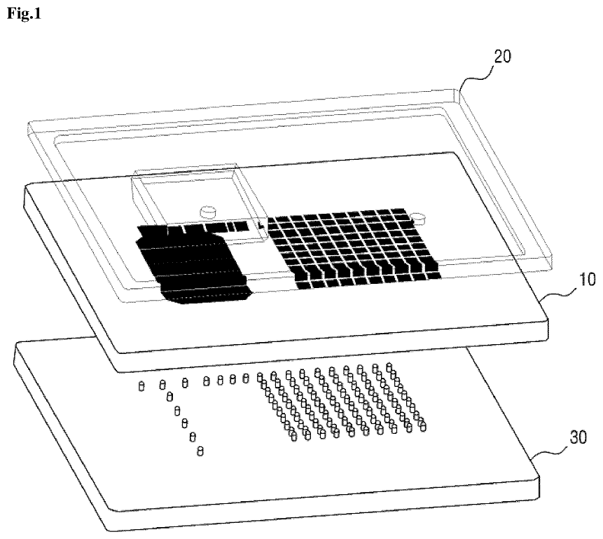

FIG. 1 is an exemplary view of a diagnostic apparatus according to an embodiment of the present invention. While FIG. 1 illustrates a diagnostic apparatus including an electrode plate 10, a housing 20, and a substrate 30, it is to be noted that FIG. 1 only illustrates a preferred embodiment for achieving the purpose of the present invention, and some components may be added or deleted as need arises. For example, a reader (not shown), which may be implemented by a computing device, may be additionally included in the diagnostic apparatus, and the reader may generate or control an electrowetting signal (i.e., an electric signal) to guide the fluid contained in the housing to a target electrode. Further, components of the exemplary diagnostic apparatus shown in FIG. 1 represent functional elements classified by functions, in an actual physical environment, a plurality of components may be implemented into an integrated form. Hereinbelow, the components of the exemplary diagnostic apparatus shown in FIG. 1 will be described in more detail.

The housing 20 may contain fluid. In an example, the housing 20 may comprise a fluid receptacle for containing the fluid. For example, a sample containing DNA may be contained in the fluid receptacle of the housing 20 for polymerase chain reaction (PCR), although the scope of the present invention is not limited thereto.

According to some embodiments, a structure of the housing 20 may further comprise components other than the fluid receptacle, depending on purpose of the diagnostic apparatus. The housing 20 may be configured to contain the fluid therein and provide additional functions in addition to the function of forming the appearance of the diagnostic apparatus, and for this, any known technology of the diagnostic apparatus may be referred.

The electrode plate 10 may induce polarization in the fluid through an electrowetting signal for moving the fluid contained in the housing 20 to a position of the target electrode. In this example, the electrode plate 10 may comprise at least one electrode for conducting an electrowetting signal.

According to some embodiments, the electrode plate 10 may comprise a base plate, and at least one electrode formed by penetrating through the base plate. In this example, the base plate may comprise an insulator. According to the embodiment, electrowetting may be used to change the surface tension between the electrode and the fluid along the electrode formed by penetrating through the electrically insulated base plate. The fluid may move between adjacent electrodes using the change in the contact angle formed by the electrode and the fluid due to such change in the surface tension. The structure of the electrode formed on the electrode plate 10 will be described in detail below.

Next, the substrate 30 may transmit an electrowetting signal to the electrode plate 10. For example, the substrate 30 may be any one of a glass substrate, a silicon substrate, a printed circuit board (PCB), and a thin film transistor (TFT). However, the scope of the present invention is not limited to these examples, and any known technology having a structure capable of transferring an electrowetting signal sent by the reader (not shown) to the electrode plate 10 may be applied in the present invention.

According to some embodiments, a reader (not shown) implemented by a computing device may be included in the diagnostic apparatus, but in an environment where the diagnostic apparatus is manufactured as disposable apparatus and a plurality of such diagnostic apparatuses are connected to the reader by a connector and used at once, it is possible to reduce the manufacturing cost of the diagnostic apparatus by excluding the reader as in the case shown in FIG. 1.

According to the exemplary diagnostic apparatus of an embodiment described above with reference to FIG. 1, the fluid contained in the housing 20 may be moved to a position of the target electrode.

Using the diagnostic apparatus described above, it is possible to automatically extract and purify the cells, vesicles, proteins, nucleic acids, etc. from a sample such as blood, urine, feces, saliva, nasopharyngeal smear, nasal cavity, oropharyngeal smear, cerebrospinal fluid, skin tissue, hair, other body cells, body tissue, semen; to perform gene amplification, detoxification, synthesis and diagnosis; to perform immunodiagnosis using antigen-antibody reactions; and to synthesize and manufacture compounds. Further, it is also possible to test heavy metals, toxic substances against human body, and drugs. However, the technical fields where the diagnostic apparatus illustrated above can be used are merely illustrative, and it is to be noted that the above diagnostic apparatus may be used in other various technical fields.

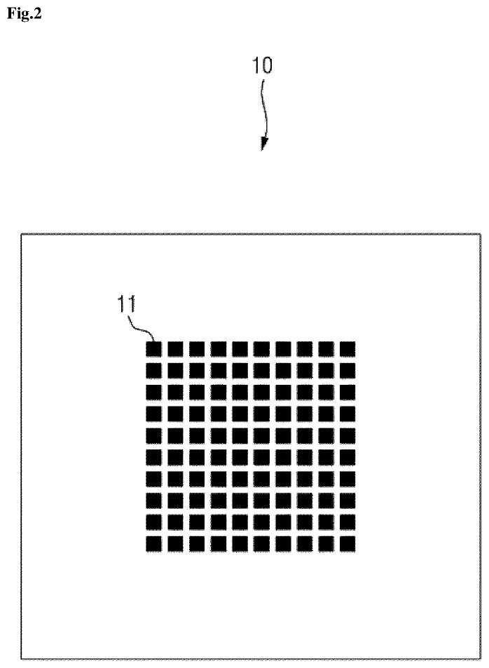

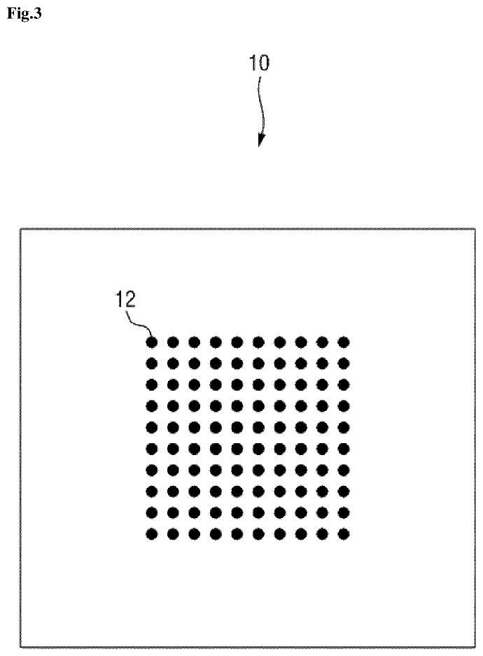

Hereinbelow, referring to FIGS. 2 to 4, the structure of the electrode plate 10 will be described in more detail. FIG. 2 is an exemplary view of an upper portion of the electrode plate 10 described by referring to FIG. 1, FIG. 3 is an exemplary view of a lower portion of the electrode plate 10 described by referring to FIG. 1, and FIG. 4 is an exemplary cross-sectional view of the electrode plate 10 described by referring to FIG. 1.

FIG. 2 illustrates an exemplary structure of an upper portion 11 of an electrode formed on an upper portion of the electrode plate 10. The upper portion 11 of the electrode shown in FIG. 2 is formed in a square shape, but it is to be noted that this is only an example and the structure of the upper portion 11 of the electrode may vary.

FIG. 3 illustrates an exemplary structure of a lower portion 12 of an electrode formed on a lower portion of the electrode plate 10. The lower portion 12 of the electrode shown in FIG. 3 is formed in a circle, but it is to be noted that this is only an example and the structure of the lower portion 12 of the electrode may vary.

FIG. 4 illustrates an exemplary side structure of an electrode. Referring to FIG. 4, the electrode 13 may be formed by penetrating through the base plate. With respect to the electrode, according to some embodiments, the electrode may be formed by injection molding a conductive plastic. According to the embodiment, it is possible to manufacture the electrodes of the diagnostic apparatus in a simple process and without using complex process similar to the semiconductor process that includes photolithography, metal deposition, etc.

With respect to the electrode, according to some other embodiments, the conductive plastic that forms the electrode may comprise a mixture of polycarbonate (PC). In this example, the mixture may comprise PC, and also at least one of conductive materials such as carbon nanotube, graphene, carbon fiber. In addition, all other known mixtures for conducting electric signals may be applied to the present invention for the manufacture of the electrodes.

With respect to the base plate, according to some embodiments, the insulator that forms the base plate may comprise at least one of polycarbonate (PC), poly methyl methacrylate (PMMA), cyclic olefin polymer (COP), cyclic olefin copolymer (COC), polyethylene terephthalate (PET), polyimide (PI), polyethylene (PE), acrylic, acrylonitrilebutadiene styrene (ABS), polyvinylidene fluoride (PVDF), polytetrafluoroethylene (PTFE), polystyrene (PS), polypropylene (PP), and polyvinyl chrloride (PVC). In addition, all other known configurations, including thermoplastic resins for insulating electric signals, may be applied to the present invention for the manufacture of the insulator.

With respect to the electrode and the base plate, according to some embodiments, the electrode and the base plate may be formed with double shot injection molding. More specifically, the base plate may be formed by injecting an insulator into a first space of a first mold by a first injection gate (or nozzle), and the electrode may be formed by injecting conductive plastic into a second mold or a second space of the first mold by a second injection gate (or nozzle) which is distinct from the first injection gate. In this example, the first injection gate and the second injection gate may be components comprised in an injector that is provided with two or more injection gates, but the scope of the present invention is not limited thereto, and the injection gates may be components comprised in different injection gates each provided with a single injection gate. According to the embodiment, it is possible to manufacture the electrode and the base plate including different materials in a simple process and without requiring complex processes similar to semiconductor processes that comprises photo processes, metal deposition processes, etc. In order to manufacture the electrode and the base plate including different materials, all known methods of performing double shot injection molding may be applied to the present invention.

With respect to the electrode and the base plate, according to some other embodiments, the electrode and the base plate may be formed by insert injection molding or overmolding. More specifically, the base plate may be formed by injecting an insulator into the first mold, and the electrode may be formed by inserting the resultant base plate into the second mold and then injecting the conductive plastic into the second mold. Conversely, the electrode may be formed by injecting the conductive plastic into a third mold, and the base plate may be formed by inserting the resultant electrode into a fourth mold and then injecting an insulator into the fourth mold. According to the embodiment, it is possible to manufacture the electrode and the base plate formed with different configurations in a simple process and without requiring complex processes similar to semiconductor processes that includes photo processes, metal deposition processes, etc.

In addition to the double shot injection molding, the insert injection molding, and the overmolding described above, various means for injection molding with different materials to manufacture products including two or more different materials may be comprised within the scope of the present disclosure.

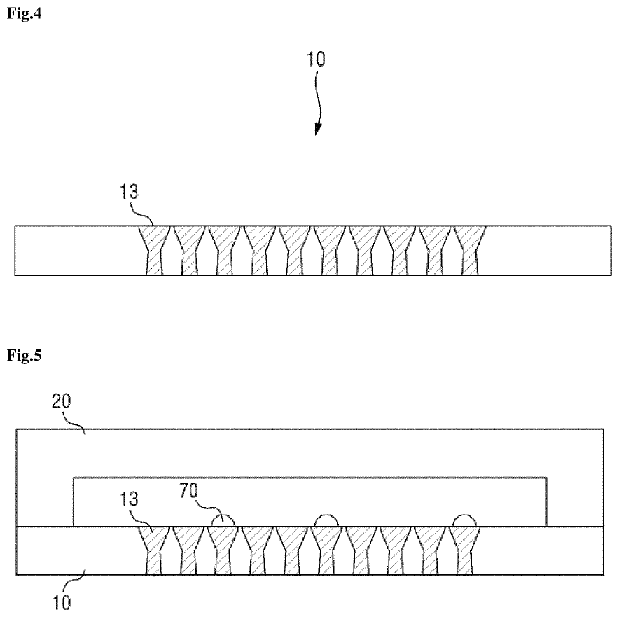

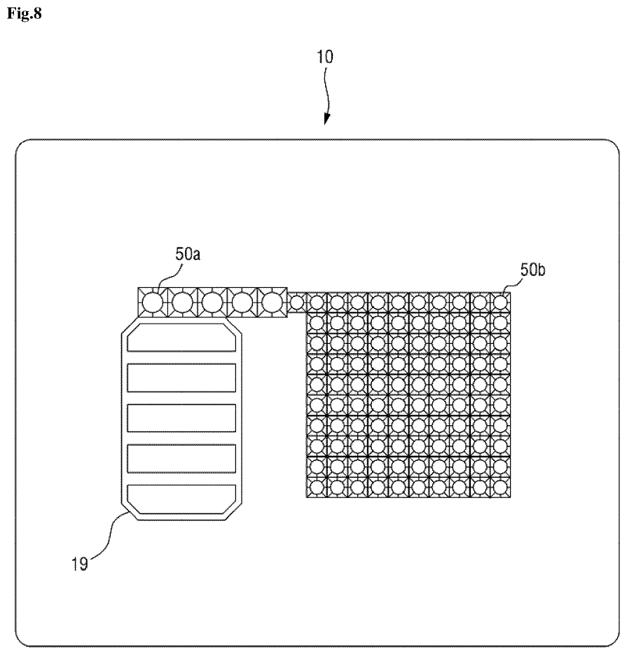

As shown in FIG. 5, the housing 20 may be coupled to the upper portion of the electrode plate 10 which may be formed according to the various methods described above. In this example, the fluid contained in the fluid receptacle (not shown) of the housing 20 may be moved along the electrode 13 formed on the electrode plate 10 based on the electrowetting signal. According to some embodiments, the fluid may be moved to a position and/or a direction guided by the electrowetting signal, through a space between an upper surface of the electrode 13 formed on the electrode plate 10 and a lower surface of the housing facing the upper surface of the electrode. FIG. 5 illustrates an example of a fluid 70 moving along the electrode 13 based on the electrowetting signal, and the movement of the fluid contained in the fluid receptacle (not shown) of the housing 20 will be described in detail below with reference to FIG. 8.

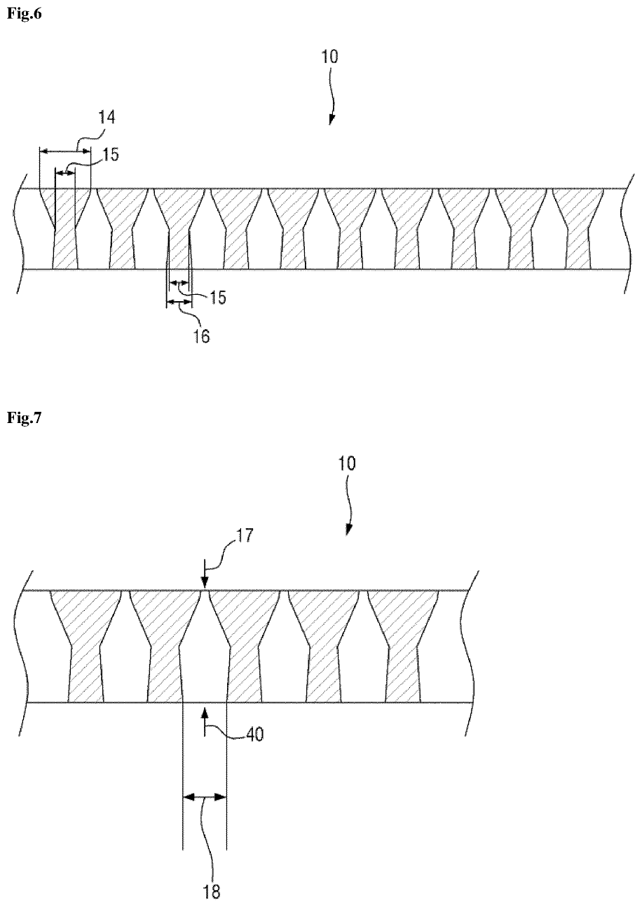

Hereinbelow, referring to FIGS. 6 and 7, the structure of the electrode and the base plate comprised in the electrode plate 10 will be described in detail. FIG. 6 is an exemplary view provided to explain in more detail the structure of the electrode described with reference to FIGS. 2 to 4, and FIG. 7 is an exemplary view provided to explain in detail the structure of the base plate described with reference to FIGS. 2 to 4. The electrode illustrated in FIG. 6 and the base plate illustrated in FIG. 7 are examples provided only for explaining some embodiments of the present invention, and the scope of the present disclosure is not limited to the structures illustrated in FIGS. 6 and 7.

Referring to FIG. 6, an upper width 14 of the electrode formed on the electrode plate 10 is larger than a middle width 15 of the electrode by a first reference size, and a lower width 16 of the electrode is larger than the middle width 15 of the electrode by a second reference size. In this example, the middle portion of the electrode may indicate any location between the upper and lower portions of the electrode. According to some embodiments, the position of the middle portion of the electrode may vary depending on the purpose of the diagnostic apparatus, and it should be construed that any electrode may be comprised within the scope of the present invention as long as the electrode has a structure in which the middle width 15 of the electrode is formed to be smaller than the upper width 14 of the electrode and the lower width 16 of the electrode. Further, it is to be noted that the first reference size and the second reference size may vary depending on the purpose of the diagnostic apparatus.

With respect to the reference sizes, according to some embodiments, the first reference size may be larger than the second reference size. Since the upper portion of the electrode plate is a part in contact with the fluid and the lower portion of the electrode plate 10 is a part where electric signals are conducted, the upper width 14 of the electrode may be preferably larger than the lower width 16 of the electrode.

With respect to the electrode, according to some embodiments, the width of the electrode may be tapered from the upper portion of the electrode toward the middle portion of the electrode and from the lower portion of the electrode toward the middle portion of the electrode. According to the embodiment, since the adhesion between the electrode and the base plate including different structures is enhanced, the yield of the electrode plate 10 can be improved and the defect rate can be lowered.

According to some other embodiments, the electrode may be formed such that the upper width is larger than or equal to the middle width of the electrode, and the middle width of the electrode is larger than or equal to the lower width of the electrode. According to some embodiments, the electrode may be formed in a shape that is tapered from the upper portion toward the lower portion.

The structure of electrodes according to some embodiments has been described above by referring to FIG. 6. It is to be noted that, in addition to the illustration in FIG. 6, the upper width 14, the middle width 15, and the lower width 16 of the electrode may vary respectively.

FIG. 7 illustrates an exemplary electrode gap formed by two or more electrodes formed in the electrode plate 10. In this example, the electrode gap may be the base plate portion including the insulator.

With respect to the electrode gap, according to some embodiments, an upper width 17 of the electrode gap may be smaller than a lower width 18 of the electrode gap. In this example, the base plate of the electrode gap may be formed by placing an injection gate through a lower portion of the electrode gap and injecting the insulator. By forming the lower width 18 of the electrode gap to be larger than the upper width 17 of the electrode gap, the pressure generated when injecting the insulator to form the base plate may be reduced. By reducing the pressure generated during injection of the insulator, the yield rate of the electrode plates 10 can be increased and the defect rate can be lowered.

With respect to the electrode gap, according to some other embodiments, the width of the electrode gap may be tapered from the middle portion of the electrode gap toward the upper portion, and tapered from the middle portion of the electrode gap toward the lower portion. According to the embodiment, since the adhesion between the electrode and the base plate including different structures is enhanced, the yield of the electrode plate 10 can be improved and the defect rate can be lowered.

Hereinbelow, with reference to FIG. 8, a reservoir 19 and electrodes 50a and 50b, which may be comprised in the electrode plate 10, will be described in detail. FIG. 8 is another exemplary view of the upper portion of the electrode plate described with reference to FIG. 1.

As illustrated in FIG. 8, the electrode plate 10 may further comprise a reservoir 19 which dispenses the fluid contained in the housing 20. According to the embodiment, first, the fluid contained in the housing 20 may be introduced into the reservoir 19. Further, the reservoir 19 according to the disclosure may be formed of various structures to dispense the fluid to adjacent electrodes. For example, a structure that fluid flows directly into the reservoir 19 from the outside without passing through the housing 20 is not excluded from the scope of the present disclosure.

Further, as illustrated in FIG. 8, the adjacent electrode 50a of the electrodes formed in the base plate, which is formed adjacent to the reservoir 19, may have an upper width larger than an upper width of the other electrode 50b. Compared with the other electrode 50b, the adjacent electrode 50a is located closer to the reservoir 19, and accordingly, located on a path of the fluid which will inevitably pass therethrough while moving to the target electrode based on the electrowetting signal. Therefore, in order for the adjacent electrode 50a to contain a larger amount of the fluid than that in the other electrode 50b or to induce electrowetting by applying voltage to a large amount of fluid, the adjacent electrode 50a may be sized to be relatively larger than the other electrode 50b.

For the adjacent electrode, according to some embodiments, a number of adjacent electrodes 50a may be determined based on the size of the reservoir 19. For example, a number of adjacent electrodes 50a may be increased for the bigger sized reservoir 19, and a number of adjacent electrodes 50a may be decreased for the smaller sized reservoir 19. Although a number of adjacent electrodes 50a illustrated in FIG. 8 is 5, this is only exemplary, and the scope of the present invention is not limited thereto.

The diagnostic apparatus according to an embodiment has been described above with reference to FIGS. 1 to 8. According to the embodiment, unlike the related diagnostic apparatus in which metal electrodes are deposited and formed, the diagnostic apparatus can be manufactured in a simple process. By simplifying the manufacturing process of the diagnostic apparatus according to the embodiment, the manufacturing cost of the diagnostic apparatus can be reduced, and also can be reduced to a manufacturing cost suitable for a disposable cartridge (or disposable kit).

In addition, compared to the related diagnostic apparatus manufacturing process including photo process, metal deposition process, etching process, etc., according to the embodiment, it is possible to provide a diagnostic apparatus with a structure that can increase yield and reduce defect rate through a very simple injection molding process.

Further, according to the embodiment, it is possible to provide a diagnostic apparatus having a structure that allows smooth flow of the fluid contained in the housing along the reservoir and the electrodes based on the electrowetting signal.

Various embodiments of the present invention and effects thereof have been mentioned above with reference to FIGS. 1 to 8. However, the effects according to the technical idea of the present invention are not limited to the effects mentioned above, and other effects not mentioned herein will be clearly understood by those skilled in the art from the description of the specification. Even when all the components of the embodiment are described as being combined or operated in combination, the technical idea of the present invention is not necessarily limited thereto. That is, as long as it is within the scope of the present invention, one or more of those components may be selectively combined and operated.

Although embodiments of the present invention have been described above with reference to the attached drawings, those skilled in the art will understand that the present invention may be implemented in other specific forms without changing the technical idea or essential features. Therefore, the embodiments described herein should be understood in all respects as illustrative and not restrictive. The scope of protection of the present invention shall be interpreted in accordance with the claims below, and all technical ideas within the equivalent scope shall be construed as being included in the scope of rights of the technical ideas defined by the present invention.

1. A diagnostic apparatus comprising:
a base plate including an insulator; and
one or more electrodes formed by penetrating through the base plate and causing a fluid located on a surface to be moved based on an applied voltage,
wherein the base plate is formed by injecting the insulator into a first space of a mold by a first injection gate, and the electrode is formed by injecting conductive plastic into a second space of the mold by a second injection gate distinct from the first injection gate.

2. The diagnostic apparatus of claim 1, wherein an upper width of the electrode is larger than a middle width of the electrode by a first reference size, and a lower width of the electrode is larger than the middle width of the electrode by a second reference size, and
the first reference size is larger than the second reference size.

3. The diagnostic apparatus of claim 2, wherein a width of the electrode is tapered from an upper portion of the electrode to a middle portion and tapered from a lower portion of the electrode to the middle portion.

4. The diagnostic apparatus of claim 1, wherein an upper width of the electrode is larger than or equal to a middle width of the electrode, and the middle width of the electrode is larger than or equal to a lower width of the electrode.

5. The diagnostic apparatus of claim 1, wherein the conductive plastic comprises at least one of carbon nanotubes, graphene, and carbon fiber.

6. The diagnostic apparatus of claim 1, wherein the insulator comprises at least one of polycarbonate (PC), poly methyl methacrylate (PMMA), cyclic olefin polymer (COP), cyclic olefin copolymer (COC), polyethylene terephthalate (PET), polyimide (PI), polyethylene (PE), acrylic, acrylonitrile butadienestyrene (ABS), polyvinylidene fluoride (PVDF), polytetrafluoroethylene (PTFE), polystyrene (PS), polypropylene (PP), and polyvinyl chrloride (PVC).

7. The diagnostic apparatus of claim 1, wherein an upper width of an electrode gap formed by two or more electrodes is smaller than a lower width of the electrode gap.

8. The diagnostic apparatus of claim 7, wherein a width of the electrode gap is tapered from a middle portion of the electrode gap toward an upper portion and tapered from the middle portion of the electrode gap toward a lower portion.

9. The diagnostic apparatus of claim 7, wherein the base plate of the electrode gap is formed by injecting the insulator into a lower portion of the electrode gap.

10. The diagnostic apparatus of claim 1, further comprising a reservoir for dispensing the fluid contained in a housing.

11. The diagnostic apparatus of claim 10, wherein an adjacent electrode of the electrodes formed in the base plate, which is formed adjacent to the reservoir, has an upper width larger than an upper width of the other electrode formed in the base plate.

12. The diagnostic apparatus of claim 11, wherein a number of adjacent electrodes is determined based on a size of the reservoir.

13. A diagnostic apparatus comprising:
a base plate including an insulator; and
one or more electrodes formed by penetrating through the base plate and causing a fluid located on a surface to be moved based on an applied voltage,
wherein the base plate is formed by injecting an insulator into a first mold, and the electrode is formed by injecting conductive plastic into a second mold distinct from the first mold.
